(19) United States
(12) Patent Application Publication
(10) Pub. No.: US 2009/0327338 A1
(43) Pub. Date: Dec. 31, 2009

(54) HIERARCHY EXTRACTION FROM THE WEBSITES

(75) Inventors: Yu ZHAO, Beijing (CN); Jianqiang LI, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/491,573

(22) Filed: Jun. 25, 2009

(30) Foreign Application Priority Data
Jun. 26, 2008 (CN) 200810111482.2

(51) Int. Cl. G06F 17/00

(52) U.S. Cl. 707/103 R; 707/E17.055

(57) ABSTRACT

The present invention provides methods and systems for building object hierarchy. The method includes: obtaining a set of web pages from a website; conducting an inter-page analysis on the obtained web pages to extract a hierarchy of the web pages; conducting an intra-page analysis on each of the obtained web pages to identify the semantic blocks within the web page and extract a hierarchy of the semantic blocks for all the web pages; and fusing the hierarchy of the semantic blocks with the hierarchy of the web pages to generate a coordinated hierarchy. In one embodiment, the nodes on the generated coordinated hierarchy are then mapped into corresponding objects to generate the coordinated object hierarchy. Compared with the prior arts, the object hierarchy building systems and methods according to the present invention can build the object hierarchy in a more accurate and efficient way by fusing the inter-page analysis result and the intra-page analysis result.

### FIELD OF THE INVENTION

The present invention generally relates to methods and systems for harvesting domain knowledge from the Web. In particular, the present invention is directed to such systems and methods that allow automatic object hierarchy building/generation from the web.

### BACKGROUND

Nowadays, Computer has become a necessary tool of modern life to help people find interested information, especially in the Internet era that a growing huge amount of diversified information has being accumulated on the Web. Although a computer is fast at information processing such like computing, storing, or searching, its incapability in understanding information is the main obstacle for intelligent information processing. To deal with that problem, semantic relevant research for intelligent information processing becomes popular recently. For example, there are relevant technologies described in T. Berners-Lee, J. Hendler, O. Lassila (2001), entitled “The Semantic Web, Scientific American”, May 2001, pp. 28-37, Nigel Shadbolt, Tim Berners-Lee and Wendy Hall, entitled “The Semantic Web Revisited”, IEEE Intelligent Systems 21(3) pp. 96-101, May/June 2006, and E. Hyvonen (editor), entitled “Semantic Web Kick-Off in Finland—Vision, Technologies, Research, and Applications”, HIIT Publications, 2002-001, Helsinki Institute for Information Technology (HIIT), Helsinki, Finland, 304 pp. They concentrate on the formats and technologies to help computer understand information. Based on some mathematic logics, such as Description Logies or Frame Logics, for knowledge representation from traditional discipline of Artificial Intelligent (AI) and the popular web information processing technologies, standard organizations, like World Wide Web Consortium (W3C), are actively specifying the standards like XML, RDF (Resource Description Framework) and OWL (Web Ontology Language), and rule languages (e.g., Web Rule Language, Rule Markup Language), which will serve as foundation to advancing the adoption of semantic technologies. Also, many developers, entrepreneurs, and practitioners have entered the stage of creating and deploying relevant tool sets, products, case studies, and even real working applications to make the vision of semantic based intelligent information utilization come true.

However, to employ the computer's powerful computing capability and the semantic relevant standards for providing different intelligent information utilization services to the Web user, the backend domain knowledge (Currently, ontology is a dominated way for knowledge representation on the Web) plays the key role inside. Thus, domain knowledge building becomes an important problem that must be solved.

Currently, there are mainly two kinds of the domain knowledge: ontology and hierarchy.

Ontology is a document or file that formally defines the relations among terms, and most typical kind of ontology for the Web has a taxonomy and a set of inference rules. Further, the taxonomy defines classes of objects and relations among them. For example, an address may be defined as a type of location, and city codes may be defined to apply only to locations, and so on. Ontology may express a rule like “If a city code is associated with a state code, and an address uses that city code, then that address has the associated state code.” A program could then readily deduce, for instance, that a Cornell University address, being in Ithaca, must be in New York State, which is in the U.S., and therefore should be formatted to U.S. standards.

A hierarchy contains nodes, and edges which connect nodes, sometimes instances attached to nodes. Compared with ontology, hierarchy is a form much simpler. Many elements in ontology, like class, property, definition and relation, can be ignored in hierarchy. But there are some ways to reason those elements from hierarchy. Thus, a hierarchy can be looked on as a kind of pseudo ontology with explicit but informal specification.

There are mainly two kinds of ontology building (OB) methods in prior arts, i.e. ontology building based on some raw material and ontology building based on some existing ontologies. In the raw material-based ontology building method, for example, the ontology can be built from texts, dictionary, a knowledge base, semi-structured data or relation schemas. In the existing ontology-based ontology building method, by comparing texts or context of concepts, several existing ontologics can be integrated into one.

Although ontology is crucial for Semantic Web and relevant services, it is difficult to build a formal ontology automatically anyway, because ontology usually contains many contents that are difficult to be filled even by human, such as class, class definition, relation of classes, property and so on. Obviously, the complex format of ontology has blocked its large-scale construction and then the widespread applications like some real-time Web services. Moreover, the ontology integration is usually performed through human interaction, and thus it is not as easily implemented as the hierarchy integration.

There are also a few prior arts for the hierarchy building (HB). For example, the Japanese Patent JP2001-34635 (hereinafter which is referred to as reference document 1) claims a method building hierarchy from the Web. Concretely, one term (i.e., one node) is extracted from each web page, and a hierarchical relation is building based on links between web pages. Instead of building the relation among all pages, the method does it only on the same type of web pages. For example, a link between two product-pages is kept, but a link between a product page and an advertisement page is ignored. In addition, in N. Liu, C. C. Yang, entitled “A link classification based approach to website topic hierarchy generation” (WWW2007) (hereinafter which is referred to as reference document 2), it is provided a method for extracting the hierarchical relations between web pages within a website based on inter-page link structure analysis. Then, it wraps each web page into a topic object and builds a topic hierarchy. The disclosures of the above-mentioned reference documents 1 and 2 are hereby incorporated entirely by reference for all the purposes.

However, as for the prior arts for HB (such as the technologies described in reference documents 1 and 2), the existing methods only consider the case that an object/topic is represented by a whole page, and the relationships among object/topics are acquired by the inter-page hyperlink analysis. However, only parts of objects/topics (nodes of hierarchy) could be representative by a whole page, while other pans of objects are only covered by some parts of a web page. Additionally, the hyperlink extracted from only the inter-page relationships are not accurate enough, since there exist much noise other than hierarchical relations within the links between pages.

### SUMMARY OF THE INVENTION

In view of the deficiencies of the HB methods in the prior arts, the present invention is made for automatically extracting hierarchy of the objects (e.g. products) from a website in a more accurate and efficient way.

In this present invention, it is proposed a coordinated method for automatic hierarchy extraction from websites by integrating inter-page analysis (i.e. analysis of hierarchy of web pages) with intra-page analysis (i.e. analysis on relationship among semantic blocks within a web page). The hierarchical relations implied within the semantic blocks inside pages are exploited to amend the inaccurate hierarchy that comes only from the inter-page analysis.

More specifically, the coordinated hierarchy extraction method of the present invention mainly includes three phases: (1) inter-page hierarchy analysis; (2) intra-page hierarchy analysis; and (3) coordinated hierarchy generating.

During the inter-page hierarchy analysis, the hierarchy is generated based on the semantic relation analysis of the whole page set of a website. On the one side, the nested objects are distilled from the websites, and bind each topic together with its representative page. On the other side, the hierarchical relations between web pages are identified with hyperlink-based method or hybrid method, which integrates the analysis of hyperlinks and contents. Thus, the object hierarchy can be extracted by integrating the object-page pairs and the hierarchical relations between web pages.

Then, in the intra-page hierarchy analysis, the hierarchy is generated based on the semantic block analysis inside a web page. The semantic block analysis is conducted on each page, which has bundles of hyperlinks directing to the object representative pages. And it brings nested semantic blocks, which contain these hyperlinks and the hierarchical relations between the semantic blocks. These nested semantic blocks are also wrapped as objects and thus the hierarchy of the new object set can be extracted by integrating the object-page pairs, object-block pairs and the hierarchical relations between semantic blocks.

Finally, a refined object hierarchy is generated by fusing the results of inter-page analysis and intra-page analysis. In an embodiment, the fusing operations can include calibrating the unreasonable hierarchical relations with each other and complementing the missing hierarchical relations with each other. Of course, it is easy to conceive for those skilled in the art that the fusing operation for the results of inter-page analysis and intra-page analysis is not limited to the described example.

In addition, the foregoing description is only used to briefly explain the principle of the present invention, but should not be viewed as limitation of the present invention. For example, in the above-mentioned example, the mapping operations of web pages-objects and semantic blocks-objects are divided as being performed in the phases of inter-page analysis and intra-page analysis respectively. However, in some other embodiments, the hierarchy of web pages and the nested relationship of semantic blocks, which are obtained as results of inter-page analysis and intra-page analysis, can be first fused, and then, the nodes (web pages or semantic blocks) on the coordinated hierarchy can be mapped into objects to achieve the final object hierarchy.

According to one aspect of the present invention, it is provided a method for hierarchy building, comprising: obtaining a set of web pages from a website; conducting an inter-page analysis on the obtained web pages to extract a hierarchy of the web pages; conducting an intra-page analysis on each of the obtained web pages to identify the semantic blocks within the web page and extract a hierarchy of the semantic blocks for all the web pages; and fusing the hierarchy of the semantic blocks with the hierarchy of the web pages to generate a coordinated hierarchy.

According to another aspect of the present invention, it is provided a system for hierarchy building, comprising: a web page obtaining means for obtaining all web pages from a website; an inter-page analysis means for conducting an inter-page analysis on the obtained web pages to extract a hierarchy of the web pages; an intra-page analysis means for conducting an intra-page analysis on each of the obtained web pages to identify the semantic blocks within the web page and extract a hierarchy of the semantic blocks for all the web pages; and a fusing means for fusing the hierarchy of the semantic blocks with the hierarchy of the web pages to generate a coordinated hierarchy.

Since the present invention focuses on hierarchy but not ontology, it makes possible to deal with many real cases of domain knowledge building. Moreover, the present invention can facilitate the reuse of existing informal or semi-formal knowledge in the Web sites and reflect the common understanding of the world/domain as much as possible.

In addition, the adopted coordinated object hierarchy extraction method in the present invention can get higher accuracy of hierarchy than either inter-page analysis based method or intra-page analysis based method. The results of inter-page analysis method and intra-page analysis can be calibrated and complemented by each other.

Also, since the intra-page analysis adopted in the present invention can conduct only on the pages that have bundles of hyperlinks directing to the object representative pages, which could be identified during inter-page analysis, it can get higher efficiency than that intra-page analysis is conducted for every pages of the website.

The foregoing and other features and advantages of the present invention can become more obvious from the following description in combination with the accompanying drawings. Please note that the scope of the present invention is not limited to the examples or specific embodiments described herein.

### BRIEF DESCRIPTIONS OF THE DRAWINGS

The foregoing and other features of this invention may be more fully understood from the following description, when read together with the accompanying drawings in which:

FIG. 1A is a block diagram for illustrating the internal structure of the coordinated object hierarchy building system 100a according to the first embodiment of the present invention;

FIG. 1B is a flow chart for explaining the operation of the coordinated object hierarchy building system 100a as shown in FIG. 1A;

FIG. 2A is a block diagram for illustrating the internal structure of the coordinated object hierarchy building system 100b according to the second embodiment of the present invention;

FIG. 2B is a flow chart for explaining the operation of the coordinated object hierarchy building system 100b as shown in FIG. 2A;

FIG. 3A is a block diagram for illustrating the internal structure of the coordinated object hierarchy building system 100c according to the third embodiment of the present invention;

FIG. 3B is a flow chart for explaining the operation of the coordinated object hierarchy building system 100c as shown in FIG. 3A;

FIG. 4 is a block diagram for illustrating in more details the internal structure of the filtering means 302 for identifying object-relevant web pages included in the coordinated object hierarchy building system 100c according to the third embodiment of the present invention;

FIG. 5 is a block diagram for illustrating the internal structure of an example of the intra-page analysis means 103 for performing the intra-page hierarchy analysis;

FIG. 6 is a schematic diagram for explaining the process of semantic block title extraction and the process of fusing and mapping;

FIG. 7 is a block diagram for illustrating in more details the internal structures of the fusing means and the mapping means included in the coordinated object hierarchy building system according to the present invention; and

FIG. 8 is a schematic block diagram of the computer system that is used to implement the present invention.

### DETAILED DESCRIPTION OF THE PREFERRED EMBODIMENTS

The exemplified embodiments of the present invention will be described below with reference to the accompanying drawings. It should be realized that the described embodiments are only used for illustration purpose, and should not be viewed as limiting the scope of the present invention.

The present invention is directed to such systems and methods for knowledge extraction, management, and utilization. In particular, the present invention provides a method and system for highly accurate and efficient object hierarchy extraction by for example considering a set of web pages from a website. Of course, it can be realized by those skilled in the art that the application of the present invention is not limited to the examples provided here, but can also be similarly used for analysis and management of domain knowledge from other knowledge sources.

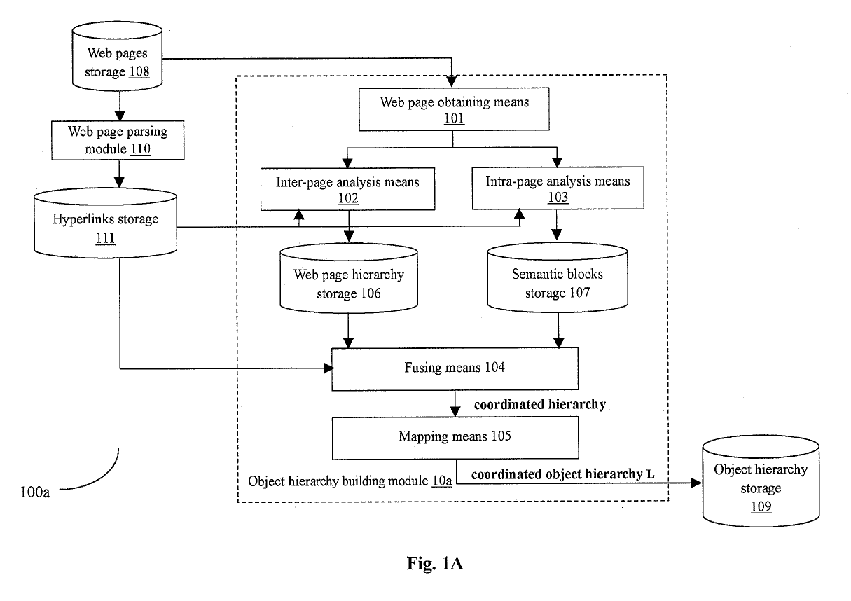

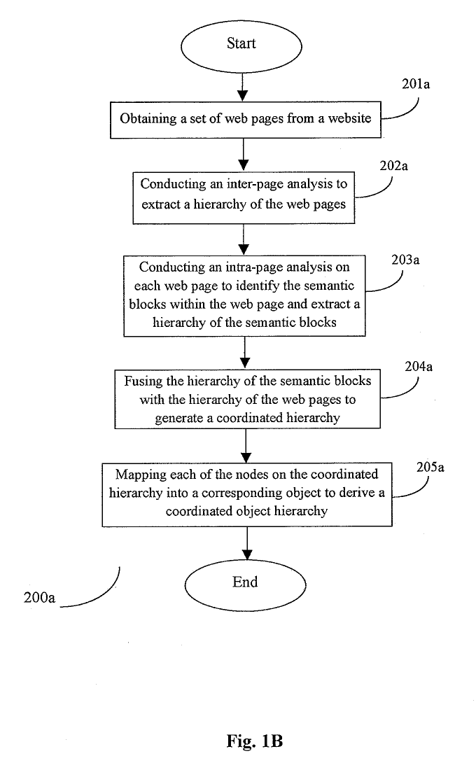

First, FIG. 1A is a block diagram for illustrating the internal structure of the coordinated object hierarchy building system 100a according to the first embodiment of the present invention, and FIG. 1B is a flow chart for explaining the operation of the system 100a as shown in FIG. 1A. As shown in FIG. 1A, the core part of the system 100a lies in the object hierarchy building module 10a, which can obtain, from the web pages storage 108, a set of web pages from a website, and after processing, build an object hierarchy L for the website, which can later be stored in the object hierarchy storage 109. A website crawling application (not shown) can download from the Internet sets of web pages from one or more websites and store the obtained web pages in the web pages storage 108 for hierarchy extraction. A web page parsing module 110 can be used to parse the web pages in the web pages storage 108 to extract hyperlinks information among the web pages and store the extracted information to the hyperlinks storage 111. As shown, the object hierarchy building module 10a can include a web page obtaining means 101, an inter-page analysis means 102, an intra-page analysis means 103, a fusing means 104 and a mapping means 105. In addition to these components, the object hierarchy building module 10a can also include a web page hierarchy storage 106 for storing the inter-page analysis result and a semantic blocks storage 107 for storing the intra-page analysis result.

With reference to the flow chart of FIG. 1B, first, in the step 201a, the web page obtaining means 101 can obtain a set of web pages from a website. For example, the web page obtaining means 101 can obtain all the web pages of a website. Then, the inter-page analysis means 102 and the intra-page analysis means 103 can perform inter-page analysis and intra-page analysis on the obtained web pages respectively with reference to the hyperlinks information on these web pages stored in the hyperlinks storage 111, and store the hierarchy of the web pages, which is extracted as the inter-page analysis result, to the web page hierarchy storage 106, and the semantic blocks, the hierarchy of the semantic blocks and the titles of the semantic blocks, which are all extracted as the intra-page analysis result, to the semantic blocks storage 107 (steps 202a and 203a). Then, in the step 204a, the fusing means 104 can fuses the hierarchy of the web pages and the hierarchy of the semantic blocks to generate a coordinated hierarchy. In the step 205a, the mapping means 105 can then map the nodes (web pages or semantic blocks) on the coordinated hierarchy into corresponding objects so as to reach a coordinated object hierarchy, which can be stored to the object hierarchy storage 109. As described later, the mapping of the hierarchy can include napping the titles of the nodes into the titles of the objects and mapping the hierarchical relationship of the nodes into the hierarchical relationship of the objects. The finally generated coordinated object hierarchy is object (e.g. product)-related, in which the object represented by each node can be a web page or a semantic block within a web page.

The object hierarchies for different websites stored in the object hierarchy storage 109 can later be used by a variety of hierarchy related applications (not shown). The hierarchy related application can be such as a hierarchy integration application for integrating and aligning the hierarchies extracted from different websites.

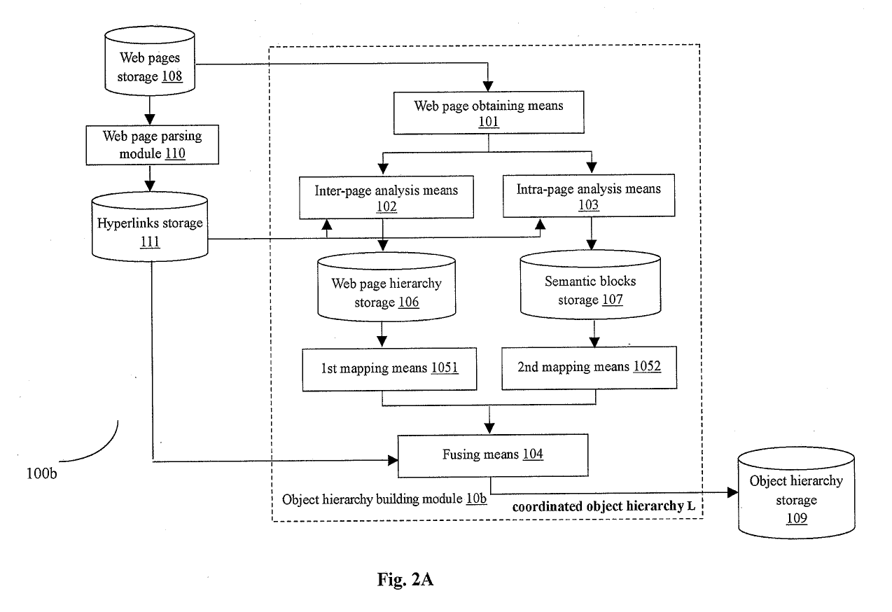

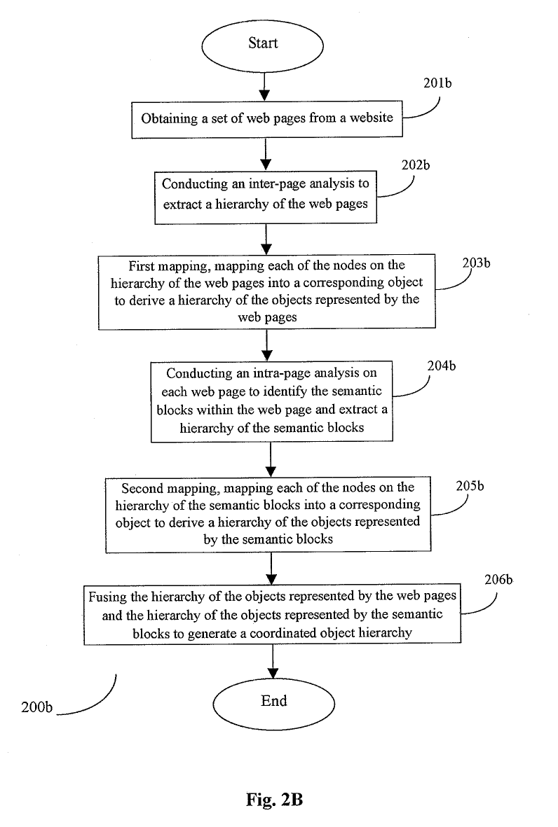

FIGS. 2A and 2B show a coordinated object hierarchy building system 100b according to the second embodiment of the present invention and its operation process. Compared with the system 100a of the first embodiment, in the second embodiment, the mapping means 105 is placed before the fusing means 104, and is configured as two means for the inter-page analysis and the intra-page analysis respectively, i.e. a first mapping means 1051 and a second mapping means 1052. The first mapping means 1051 is placed after the inter-page analysis means 102 for mapping the nodes (i.e. web pages) on the hierarchy of the web pages, which is obtained as the inter-page analysis result to the corresponding objects, so as to build a hierarchy of the objects represented by the web pages. The second mapping means 1052 is placed after the intra-page analysis means 103 for mapping the nodes (i.e. semantic blocks) on the hierarchy of the semantic blocks, which is obtained as the intra-page analysis result to the corresponding objects, so as to build a hierarchy of the objects represented by the semantic blocks. Then, the hierarchy of the objects represented by the web pages and the hierarchy of the objects represented by the semantic blocks are outputted from the first mapping means 1051 and the second mapping means 1052 to the fusing means 104 for fusing operation. In the fusing means 104, the two hierarchies can be fused to generate a coordinated object hierarchy L. Similarly to the first embodiment, the coordinated object hierarchy L can be stored in the object hierarchy storage 109.

FIG. 2B is a flow chart for explaining the operation of the coordinated object hierarchy building system 100b as shown in FIG. 2A. Compared with FIG. 1B, it can be seen that the difference between the first and second embodiments is in the first and second mapping steps 203b and 205b. In addition, since the web page-object mapping process and the semantic block-object mapping process have already been performed in the inter-page analysis and the intra-page analysis, after the fusing step 206b, the coordinated object hierarchy L can be generated directly.

As for other components shown in FIG. 2A and other steps shown in FIG. 2B which are similar to the first embodiment, their detailed description will be omitted here for the purpose of simplicity.

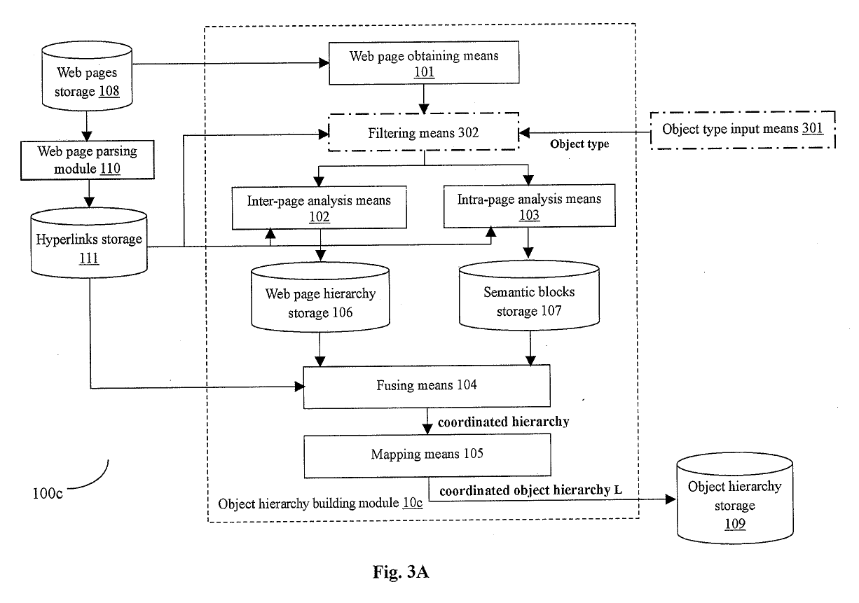

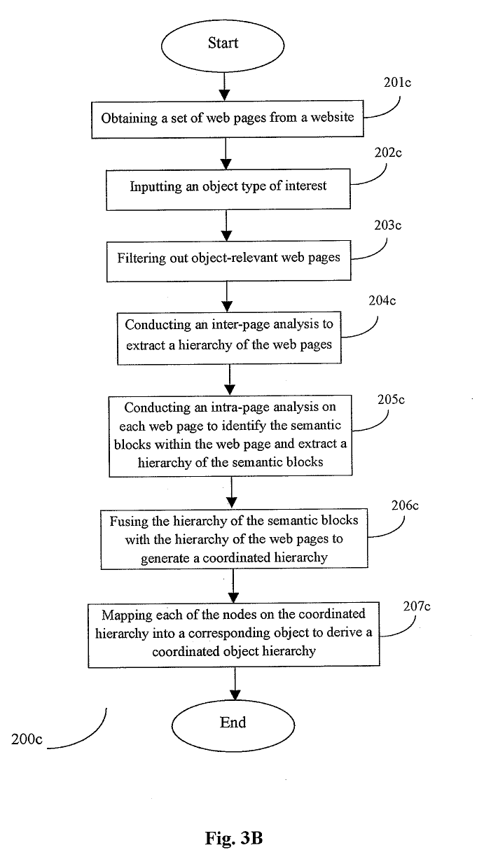

Moreover, FIGS. 3A and 3B provide a more efficient embodiment. Since the target of the invention is to generate an object-related hierarchy, during the inter-page analysis, it is considerable to first retrieve object-relevant web pages from the set of web pages that have been obtained by the web page obtaining means 101, and then only the object-relevant web pages need to be analyzed and processed to determine the hierarchical relationship. For the details, please refer to the contents in FIGS. 3A and 3B. FIG. 3A is a block diagram for illustrating the internal structure of the coordinated object hierarchy building system 100c according to the third embodiment of the present invention, and FIG. 3B is a flow chart for explaining the operation of the system 100c as shown in FIG. 3A.

Compared with the first embodiment shown in FIG. 1, in addition to the components similar to the first and second embodiments, the object hierarchy building module 10c in the system 100c shown in FIG. 3A includes an object type input means 301 and a filtering means 302. With reference to the flow chart of FIG. 3B, first, in the step 201c, similarly to the first and second embodiments, the web page obtaining means 101 acquires a set of web pages from a website from the web pages storage 108. In the step 202c, the user can input an object type that he/she is interested in through the object type input means 301. Then, the filtering means 302 can filter out those web pages having the object type that the user is interested in from the web pages acquired by the web page obtaining means 101, as object-relevant web pages (step 203c). In the step 204c, the inter-page analysis means 102 performs the inter-page analysis on only the filtered object-relevant web pages to extract the hierarchy of the object-relevant web pages. Similarly, for the intra-page analysis, the intra-page analysis means 103 can select only those pages, which have bundles of hyperlinks to the object-relevant web pages to make the intra-page semantic block analysis (step 205c). Next, similarly to the first embodiment, the fusing means 104 fuses the hierarchy of web pages built in the step 204c and the hierarchy of semantic blocks built in the step 205c to generate the coordinated hierarchy (step 206c). Then, in the step 207c, the mapping means 105 can map each of the nodes on the coordinated hierarchy into a corresponding object to build the coordinated object hierarchy. Then, the process ends.

Although the system shown in FIG. 3A is made based on the system of the first embodiment shown in FIG. 1A, it is obvious to those skilled in the art that the technical principle of the third embodiment can be similarly applied to the second embodiment shown in FIG. 2A, as long as the corresponding object type input means 301 and filtering means 302 are added to the system 100b.

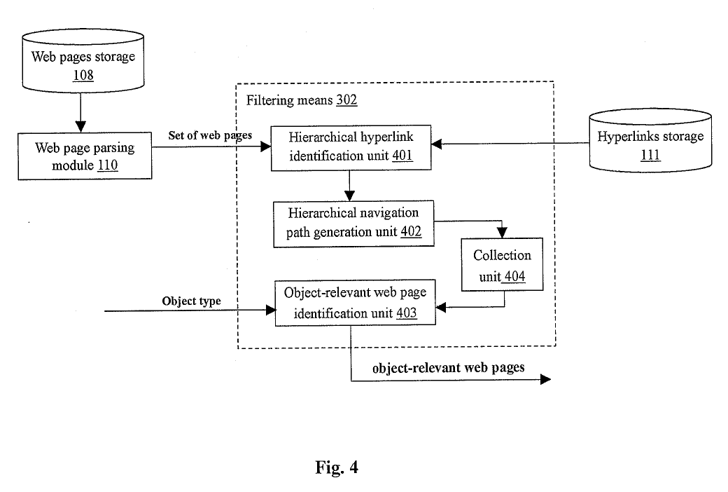

FIG. 4 is a block diagram for illustrating in more details the internal structure of the filtering means 302 for identifying object-relevant web pages. As shown, in this example, the filtering means 302 can include a hierarchical hyperlink identification unit 401, a hierarchical navigation path generation unit 402, an object-relevant web page identification unit 403 and a collection unit 404. In this example, the object-relevant web pages filtering can be conducted with hierarchical navigation path (HNP) based method. Of course, the HNP method is described here as only an example. It is easy to conceive for those skilled in the art that other proper existing methods can also be adopted to conduct the filtering of the object-relevant pages.

Basically, a HNP is associated with a specific website. It means the multi-steps of those hyperlinks with hierarchical relation between web pages which constitute the assumed navigational path to guide users' navigation from the root page of the website to the destination page. The constitutional hyperlinks of HNP, which we call as hierarchical hyperlinks (HL), are different from those reference hyperlinks which convey the peer-to-peer recommendation, and also different from those pure navigational hyperlinks which provide just shortcut from a page to another page. Instead, HLs are utilized for web page organization and embed a kind of hierarchical relation (e.g., whole-part or parent-child) between web pages, and then the semantic of parent pages could be inherited to children pages along sequential HLs, i.e. HNPs. Thus, HNPs can afford meaningful indication on the content of its destination web page.

With reference to FIG. 4, the hierarchical hyperlink identification unit 401 can be used to identify HLs from all the hyperlinks within a website. As an example, the hierarchical hyperlink identification unit 401 can adopt an algorithm to remove the pure navigational hyperlinks, i.e., the noise information corresponding to the HL, e.g., the direct/indirect sibling and upward hyperlinks. The algorithm includes two steps: 1) syntactical URL analysis, and 2) semantic hyperlink analysis. Step 1 utilizes the URL grammar, i.e., the information implied in http://[host]/[path]/[file]#[fragment] to identify if there is hierarchical relation between the source and destination web pages of a hyperlink. Then, in step 2 for semantic hyperlink analysis, the rules are adopted that if the web pages in the web page set P₁ come from the same link collection, and these pages have a common outbound page set P₂, then there is a high possibility that P₁ are the sibling pages at the same hierarchical level, and it is very likely that P₂ is included in P₁ (the pages in P₁ are linked to each other) or share the same parent page with P₁. Therefore, the hyperlinks from P₁ to P₂ are regarded as non-HLs. Here, link collection means a set of links with the same layout and presentation properties within one web page, which usually represents one of semantic blocks of the page. The above-mentioned algorithm is only used as an example of the hierarchical hyperlink identification, and should not be viewed as limitation of the invention.

After all the HLs within a website are identified, the hierarchical navigation path generation unit 402 can generate the HNP for each Web document within the website. At the same time, the linguistic contents within HNP, including the URLs, anchor texts and web page titles along it, can be collected by the collection unit 404.

Then, after the navigation paths have been generated by the hierarchical navigation path generation unit 402, the object-relevant web page identification unit 403 can conduct the path-query to retrieve object-relevant web pages or to filter out the object-irrelevant web pages, by querying the HNPs' text nodes with the object type name or its synonyms that have been inputted in advance. For example, if user wants to extract products web pages from a company website, the HNP can be queried with the keywords such as “product”, “service” and so on. If some nodes of a page's HNPs contain such these keywords, the page could be regarded as a possible object-relevant web page, because HNPs contain the exactly meaningful context of the target page. Such object-relevant web pages could be regarded as the representative pages of a series of nested objects. And the name of an object could be summarized from the corresponding web page's title and the anchor texts of the hyperlinks which direct to the corresponding web page.

After the object-relevant web pages have been filtered out by the filtering means 302, these object-relevant web pages can be provided to the inter-page analysis means 102 and the intra-page analysis means 103 for inter-page analysis and intra-page analysis.

The whole structures and principles of the coordinated object hierarchy building systems and methods according to the first, second and third embodiments of the present invention have been described above with reference to the accompanying drawings. It can be seen that the crucial technical aspects of the above-mentioned systems lie in three aspects, i.e. the inter-page hierarchy analysis (the inter-page analysis means 102), the intra-page hierarchy analysis (the intra-page analysis means 103) and the generation of the coordinated object hierarchy (the fusing means 104 and mapping means 105 in the first embodiment, or the fusing means 104, first mapping means 1051 and second mapping means 1052 in the second embodiment). These aspects will be described in more details later.

First, as for the inter-page hierarchy analysis, i.e. the operation of the inter-page analysis means 102, it can be implemented by using various methods well-known by those skilled in the art. For example, in the case of processing the object-relevant web pages, the hierarchical hyperlinks identified by the hierarchical hyperlink identification unit 401 can be used, so that if two object-relevant web pages could be linked by a sequence of hierarchical hyperlinks, then they are regarded as a parent-child pair and the hierarchical relations between them are stored. Of course, as known by those skilled in the art, there are many inter-page analysis methods in the prior art capable of being applied to the present invention. The user can choose proper method according to actual application requirement to extract the hierarchy of web pages.

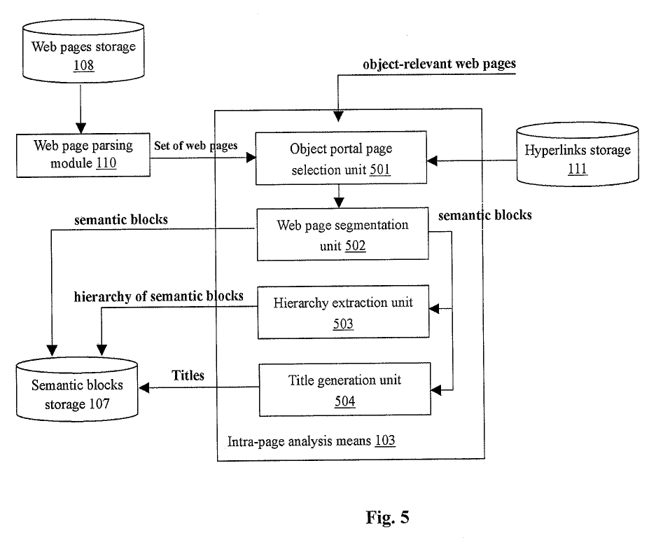

As for the intra-page hierarchy analysis, as described above, the intra-page analysis means 103 is used to divide each web page into several nested semantic blocks and extract a hierarchy of the semantic blocks. The intra-page hierarchy analysis process can also be implemented by using various methods well-known by those skilled in the art. Here, an example of the intra-page hierarchy analysis will be given with reference to FIG. 5.

FIG. 5 is a block diagram for illustrating the internal structure of an example of the intra-page analysis means 103 for performing the intra-page hierarchy analysis. As shown, in this example, the intra-page analysis means 103 can include an object portal page selection unit 501, a web page segmentation unit 502, a hierarchy extraction unit 503 and a title generation unit 504.

First, the object portal page selection unit 501 selects object portal pages from the web pages obtained by the web page obtaining means 101. The object portal pages are pages containing bundles of hyperlinks directing to different object-relevant web pages. Then, the web page segmentation unit 502 conducts web page segmentation for these selected object portal pages to generate nested semantic blocks of the pages. In order to further improve the efficiency, the web page segmentation unit 502 can only pick those semantic blocks containing the hyperlinks directing to object-relevant web pages for the following hierarchy extraction. The web page segmentation could be realized by several existing methods, such as DOM pattern repetition based method or vision layout based method. The details of existing methods are not described here. After division of the semantic blocks, the hierarchy extraction unit 503 extracts the hierarchy of the semantic blocks. Then, the title generation unit 504 can generate a title for each semantic block.

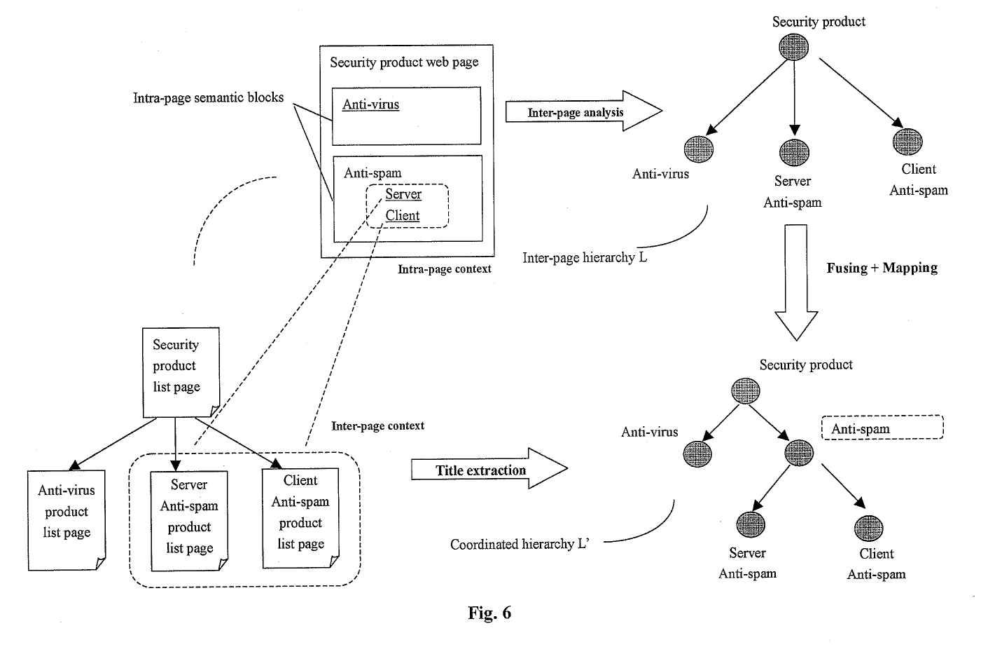

As an example, the title generation of semantic block can be realized by a hybrid context based method which identifies a title for each semantic block with analyzing and synthesizing both the intra-page context, which is for the page where the block is located, and the inter-page context, which is for the destination pages of the out-bound links inside the block, of the semantic block. For example, FIG. 6 shows an example. In this example, two semantic blocks are divided within the security product web page, i.e. an “Anti-virus” and an “Anti-spam”, in which the title of the dash-line circled semantic block “Anti-spam” needs to be extracted. For the title of the semantic block, if its text could be extracted directly from the semantic block's literal contents, then the title can be easily got. However, if such text doesn't exist or the text is embedded in an image, then we can use both the intra-page context and the inter-page context to summarize the title of this semantic block. For example, in FIG. 6, we can use both the intra-page context (the anchor texts of hyperlinks inside the semantic block “server” and “client”) and the inter-page context (the titles of the destination pages of these two hyperlinks “server anti-spam product list page” and “client anti-spam product list page) to summarize the title of this semantic block “Anti-spam”.

Finally, return to FIG. 5, the divided semantic blocks, the extracted hierarchy of the semantic blocks and the generated titles of the semantic blocks are all stored into the semantic blocks storage 107.

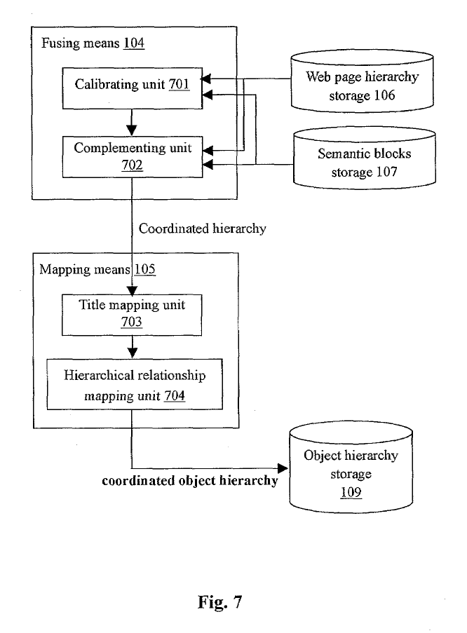

After the inter-page hierarchy analysis and the intra-page hierarchy analysis have been done, the fusing means 104 fuses the inter-page analysis result and the intra-page analysis result to generate the coordinated hierarchy. FIG. 7 is a block diagram for illustrating in more details the internal structures of the fusing means and the mapping means. In the example shown in FIG. 7, the fusing means includes a calibrating unit 701 and a complementing unit 702. The calibrating unit 701 is configured for calibrating mutually the hierarchy of the web pages and the hierarchy of the semantic blocks to solve the confliction, and the complementing unit 702 is configured for complementing the semantic blocks as virtual web pages to the hierarchy of the web pages according to the hierarchy of the semantic blocks to generate the coordinated hierarchy. For the calibrating unit 701, many existing hierarchy integration methods can be used to implement the calibration between different hierarchies. Thus, it will not be described in details here. On the other hand, since the goal of the invention is to acquire an object hierarchy and many objects are represented by a part (e.g. a semantic block) of page other than the whole page, we should complement such objects and the relations to other objects into the object hierarchy generated by the inter-page hierarchy analysis, from semantic block results (i.e. intra-page analysis results). For example, in the example shown in FIG. 6, the hierarchy of web pages generated through the inter-page analysis does not consider an object represented by the semantic block “Anti-spam”. But, after fusing process, in the coordinated hierarchy L′, the semantic block “Anti-spam”, as a new node, has been complemented to the web page hierarchy because this semantic block contains the hyperlinks to other two object-relevant web pages, i.e. “server anti-spam product list page” and “client anti-spam product list page”.

Finally, the coordinated hierarchy L′ generated by the fusing means 104 is mapped into the corresponding coordinated object hierarchy in the mapping means 105. As shown in FIG. 7, in this example, the mapping means 105 includes a title mapping unit 703 and a hierarchical relationship mapping unit 704. The title mapping unit 703 is configured for mapping the titles of the web pages or the semantic blocks represented by the nodes into the titles of the corresponding objects, and the hierarchical relationship mapping unit 704 is configured for mapping the hierarchical relationship of the web pages or the semantic blocks represented by the nodes into the hierarchical relationship of the corresponding objects. The coordinated object hierarchy generated by the mapping means 105 can then be stored in the object hierarchy storage 109 for other hierarchy relevant applications.

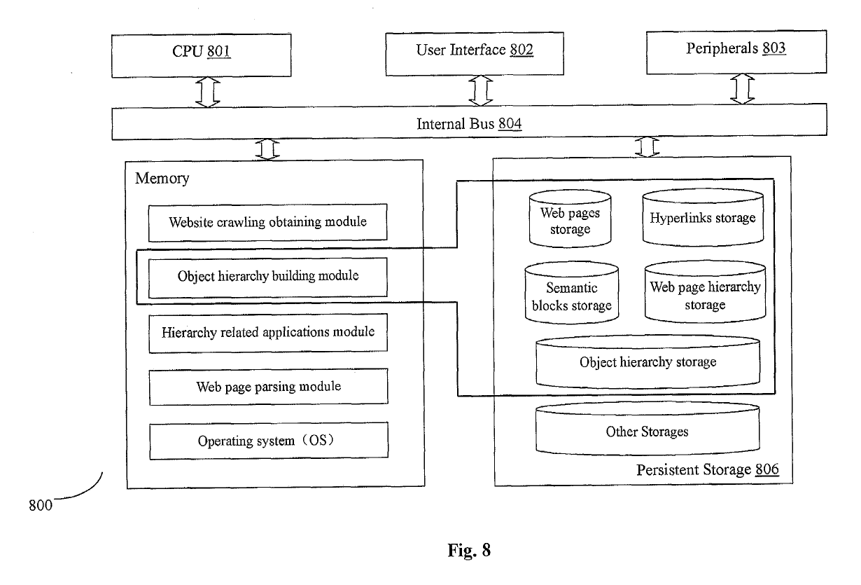

FIG. 8 is a schematic block diagram of the computer system 800 that is used to implement the present invention. As shown, the computer system 800 includes a CPU 801, a user interface 802, the peripherals 803, a memory 805, a persistent storage 806 and an internal bus 804, which connects the foregoing components with each other. The memory 805 further includes a website crawling obtaining module, an object hierarchy building module, a hierarchy related applications module, an web page parsing module and an operating system (OS) etc. The present invention is mainly related to the object hierarchy building module, which is, for example, each of the object hierarchy building modules 10a, 10b and 10c shown in FIGS. 1A, 2A and 3A. The website crawling obtaining module can be used to obtain web pages from the network and store them into the web pages storage. The web page parsing module can parse the obtained web pages to extract hyperlinks relationship of the web pages. The extracted hyperlinks relationship can be stored in the hyperlink storage. The persistent storage 806 includes various databases related to the present invention, such as the web pages storage 108, the hyperlinks storage 111, the web page hierarchy storage 106, the semantic blocks storage 107 and the object hierarchy storage 109.

The coordinated object hierarchy building systems and methods according to the first, second and third embodiments have been described above with reference to the accompanying drawings. Compared with the prior arts, the methods and systems of the present invention possess the following advantages:

First, since the present invention focuses on hierarchy but not ontology, it makes possible to deal with many real cases of domain knowledge building. Moreover, the present invention can facilitate the reuse of existing informal or semi-formal knowledge in the Web sites and reflect the common understanding of the world/domain as much as possible.

In addition, the adopted coordinated object hierarchy extraction method in the present invention can get higher accuracy of hierarchy than either inter-page analysis based method or intra-page analysis based method. The results of inter-page analysis method and intra-page analysis can be calibrated and complemented by each other.

Also, since the intra-page analysis adopted in the present invention can conduct only on the pages that have bundles of hyperlinks directing to the object representative pages, which could be identified during inter-page analysis, it can get higher efficiency than that intra-page analysis is conducted for every pages of the website.

The specific embodiments of the present invention have been described above with reference to the accompanying drawings. However, the present invention is not limited to the particular configuration and processing shown in the accompanying drawings. In the above embodiments, several specific steps are shown and described as examples. However, the method process of the present invention is not limited to these specific steps. Those skilled in the art will appreciate that these steps can be changed, modified and complemented or the order of some steps can be changed without departing from the spirit and substantive features of the invention.

The elements of the invention may be implemented in hardware, software, firmware or a combination thereof and utilized in systems, subsystems, components or sub-components thereof. When implemented in software, the elements of the invention are programs or the code segments used to perform the necessary tasks. The program or code segments can be stored in a machine-readable medium or transmitted by a data signal embodied in a carrier wave over a transmission medium or communication link. The “machine-readable medium” may include any medium that can store or transfer information. Examples of a machine-readable medium include electronic circuit, semiconductor memory device, ROM, flash memory, erasable ROM (EROM), floppy diskette, CD-ROM, optical disk, hard disk, fiber optic medium, radio frequency (RF) link, etc. The code segments may be downloaded via computer networks such as the Internet, Intranet, etc.

Although the invention has been described above with reference to particular embodiments, the invention is not limited to the above particular embodiments and the specific configurations shown in the drawings. For example, some components shown may be combined with each other as one component, or one component may be divided into several subcomponents, or any other known component may be added. The operation processes are also not limited to those shown in the examples. Those skilled in the art will appreciate that the invention may be implemented in other particular forms without departing from the spirit and substantive features of the invention. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for hierarchy building, comprising:
obtaining a set of web pages from a website;
conducting an inter-page analysis on the obtained web pages to extract a hierarchy of the web pages;
conducting an intra-page analysis on each of the obtained web pages to identify the semantic blocks within the web page and extract a hierarchy of the semantic blocks for all the web pages; and
fusing the hierarchy of the semantic blocks with the hierarchy of the web pages to generate a coordinated hierarchy.

2. The method according to claim 1, further comprising:
mapping each of the nodes on the coordinated hierarchy into a corresponding object to derive a coordinated object hierarchy.

3. The method according to claim 1, further comprising:
after the inter-page analysis, mapping each of the nodes on the hierarchy of the web pages into a corresponding object to derive a hierarchy of the objects represented by the web pages;
after the intra-page analysis, mapping each of the nodes on the hierarchy of the semantic blocks into a corresponding object to derive a hierarchy of the objects represented by the semantic blocks, and
wherein in the step of fusing, the hierarchy of the objects represented by the web pages and the hierarchy of the objects represented by the semantic blocks are fused to derive a coordinated object hierarchy.

4. The method according to claim 1, wherein the step of fusing comprises:
calibrating the hierarchy of the web pages and the hierarchy of the semantic blocks with each other to solve the confliction between them; and
complementing, according to the hierarchy of the semantic blocks, the semantic blocks as virtual web pages to the hierarchy of the web pages to generate the coordinated hierarchy.

5. The method according to claim 1, further comprising:
inputting an object type in which the user is interested; and
filtering out object-relevant web pages with the inputted object type from the obtained web pages,
wherein the inter-page analysis and the intra-page analysis are conducted on the object-relevant web pages.

6. The method according to claim 5, wherein the step of filtering comprises:
identifying hierarchical hyperlinks from the hyperlinks of the obtained web pages;
generating a hierarchical navigation path for each of the web pages with reference to the identified hierarchical hyperlinks; and
identifying the object-relevant web pages by checking the generated hierarchical navigation paths.

7. The method according to claim 6, further comprising:
collecting linguistic contents of the web pages along the generated hierarchical navigation paths, and
the step of checking comprises:
querying the collected linguistic contents of the web pages according to the inputted object type to identify the object-relevant web pages.

8. The method according to claim 1, wherein the step of conducting the intra-page analysis comprises:
conducting web page segmentation on each of the web pages to generate semantic blocks;
extracting the hierarchy of the semantic blocks for all the web pages; and
generating a title for each of the semantic blocks.

9. The method according to claim 5, wherein the step of conducting the intra-page analysis comprises:
selecting, from the obtained web pages, object portal pages, which contain bundles of hyperlinks directing to different object-relevant web pages;
conducting web page segmentation on the selected object portal pages to generate semantic blocks;
extracting the hierarchy of the semantic blocks; and
generating a title for each of the semantic blocks.

10. The method according to claim 8 or 9, wherein in the step of generating the title, if the text of the title is not included in the literal contents of the semantic block, generating the title by using intra-page context and inter-page context of the web page to which the semantic block belongs.

11. The method according to claim 2 or 3, wherein the step of mapping comprises:
mapping the title of each node into the title of the corresponding object; and
mapping the hierarchical relationship of the nodes into the hierarchical relationship of the objects.

12. A system for hierarchy building, comprising:
a web page obtaining means for obtaining all web pages from a website;
an inter-page analysis means for conducting an inter-page analysis on the obtained web pages to extract a hierarchy of the web pages;
an intra-page analysis means for conducting an intra-page analysis on each of the obtained web pages to identify the semantic blocks within the web page and extract a hierarchy of the semantic blocks for all the web pages; and
a fusing means for fusing the hierarchy of the semantic blocks with the hierarchy of the web pages to generate a coordinated hierarchy.

13. The system according to claim 12, further comprising:
a mapping means for mapping each of the nodes on the coordinated hierarchy into a corresponding object to derive a coordinated object hierarchy

14. The system according to claim 12, further comprising:
a first mapping means coupled to the inter-page analysis means for mapping, after the inter-page analysis, each of the nodes on the hierarchy of the web pages into a corresponding object to derive a hierarchy of the objects represented by the web pages;
a second mapping means coupled to the intra-page analysis means for mapping, after the intra-page analysis, each of the nodes on the hierarchy of the semantic blocks into a corresponding object to derive a hierarchy of the objects represented by the semantic blocks, and
wherein the fusing means fuses the hierarchy of the objects represented by the web pages from the first mapping means and the hierarchy of the objects represented by the semantic blocks from the second mapping means to derive a coordinated object hierarchy.

15. The system according to claim 12, wherein the fusing means comprises:
a calibrating unit for calibrating the hierarchy of the web pages and the hierarchy of the semantic blocks with each other to solve the confliction between them; and
a complementing unit for complementing, according to the hierarchy of the semantic blocks, the semantic blocks as virtual web pages to the hierarchy of the web pages to generate the coordinated hierarchy.

16. The system according to claim 12, further comprising:
an object type input means for inputting an object type in which the user is interested; and
a filtering means for filtering out object-relevant web pages with the inputted object type from the obtained web pages,
wherein the inter-page analysis means and the intra-page analysis means conduct the inter-page analysis and the intra-page analysis on the object-relevant web pages output from the filtering means respectively.

17. The system according to claim 16, wherein the filtering means comprises:
a hierarchical hyperlink identification unit for identifying hierarchical hyperlinks from the hyperlinks of the obtained web pages;
a hierarchical navigation path generation unit for generating a hierarchical navigation path for each of the web pages with reference to the identified hierarchical hyperlinks; and
an object-relevant web page identification unit for identifying the object-relevant web pages by checking the generated hierarchical navigation paths.

18. The system according to claim 17, wherein the filtering means further comprises:
a collection unit for collecting linguistic contents of the web pages along the generated hierarchical navigation paths, and
the object-relevant web page identification unit queries the linguistic contents of the web pages collected by the collection unit according to the inputted object type to identify the object-relevant web pages.

19. The system according to claim 12, wherein the intra-page analysis means comprises:
a web page segmentation unit for conducting web page segmentation on each of the web pages to generate semantic blocks;
a hierarchy extraction unit for extracting the hierarchy of the semantic blocks for all the web pages; and
a title generation unit for generating a title for each of the semantic blocks.

20. The system according to claim 16, wherein the intra-page analysis means comprises:
a object portal page selection unit for selecting, from the obtained web pages, object portal pages, which contain bundles of hyperlinks directing to different object-relevant web pages;
a web page segmentation unit for conducting web page segmentation on the selected object portal pages to generate semantic blocks;
a hierarchy extraction unit for extracting the hierarchy of the semantic blocks; and
a title generation unit for generating a title for each of the semantic blocks.

21. The system according to claim 19 or 20, wherein if the text of the title is not included in the literal contents of the semantic block, the title generation unit generates the title by using intra-page context and inter-page context of the web page to which the semantic block belongs.

22. The system according to claim 13 or 14, wherein each of the mapping means, the first mapping means and the second mapping means comprises:
a title mapping unit for mapping the title of each node into the title of the corresponding object; and
a hierarchical relationship mapping unit for mapping the hierarchical relationship of the nodes into the hierarchical relationship of the objects.
